(19) United States
(12) Patent Application Publication
(10) Pub. No.: US 2006/0177084 A1
(43) Pub. Date: Aug. 10, 2006

(54) Mask amplifier with separated elements

(76) Inventors: Greg Skillicorn, Grainger Township, OH (US); Joe Birli, Munson, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/191,698

(22) Filed: Jul. 28, 2005

Related U.S. Application Data
(60) Provisional application No. 60/592,070, filed on Jul. 29, 2004.

(51) Int. Cl. H04R 11/04

(52) U.S. Cl. 381/367

(57) ABSTRACT

Elements of a mask amplifier, including power supply, circuit board or amplifier, and microphone, that do not need external exposure, can be separated from the speaker and can be located, for example, inside the mask volume.

### RELATED APPLICATION

This application claims the benefit of U.S. Provisional Application No. 60/592,070, filed Jul. 29, 1994, the entire disclosure of which is incorporated by reference.

### BACKGROUND OF THE INVENTION

The present invention relates to the integration of portions of a mask amplifier into the mask itself.

A mask amplifier is mounted on a mask worn by a user. The mask covers the user's mouth and nose, for example, to protect the user from toxic gases. A microphone or other transducer in the mask amplifier picks up the voice of the user, the amplifier electronically amplifies the voice, and projects it from the exterior of the mask. As a result, the user's voice can be heard nearby even though the user is wearing a mask.

The four elements of a mask amplifier (also known as a voice amplifier or voice projection unit) are the sensing element (microphone or “mic”), the printed circuit board (or PC board or amplifier per se), the power supply, and the speaker. Some type of housing is used, so this may be considered a fifth element. An on/off switch is also typically included. A mask amplifier could include more than four or fewer than four elements.

The fourth element in this group (the speaker) typically needs external exposure on the mask, because it emits sound that has to be heard outside of the mask. (The speaker may be located behind a membrane or grille that is attached to or is part of the mask; in this case, the speaker is still considered to be externally mounted—it is outside the mask volume that is defined by the seal of the mask against the user's face, or forms part of that seal.)

The mask amplifier is typically provided as a single integrated unit that includes all four of these elements in one enclosure. The one unit clips on the outside of the mask or is at least partially fitted into an opening in the mask, such as a voice emitter passage. The single unit configuration is advantageous in that it allows the entire unit to be removed when it is not needed, or when the battery needs replacing, for example. Alternatively, the mask amplifier may be provided with a microphone mounted inside the mask volume, that is hardwired to an external unit including the other three elements.

Another known mask has an internal microphone that plugs into a connector. The connector connects via hardwires in the mask to a port on the outside of the mask. A cable plugs onto that port and carries the microphone signal out to an amplifier and speaker and a power source on the user's waist or body. The mask has an internal HUD display (four LED's) inside the mask that receives its signal through this port. The internal HUD unit has a board that supports the LED's. There is no internal (or even mask-mounted) circuitry for the mask amplifier. All elements of the mask amplifier (other than the microphone itself) are mounted off the mask.

### SUMMARY OF THE INVENTION

Three elements of the mask amplifier—power supply, PC board, and microphone—do not need to be on the outside of the mask, or outside the mask volume, because they do not need external exposure. Rather, these three elements can be internal or integrated into the mask, or inside the mask volume. The invention therefore provides for various combinations (separations) of the four elements, as shown and described below. In addition, the invention provides various ways of mounting the elements, and of electrically interconnecting the elements.

### BRIEF DESCRIPTION OF THE DRAWINGS

Further features and advantages of the present invention will become apparent to those of ordinary skill in the art to which the invention pertains from a reading of the following description together with the accompanying drawings, in which:

FIG. 1 is a schematic illustration of a mask and mask amplifier that are a first embodiment of the invention;

FIG. 2 is a schematic illustration of a mask and mask amplifier that are a second embodiment of the invention;

FIG. 3 illustrates schematically an alternative separation arrangement of the elements of a mask amplifier; and

FIG. 4 illustrates schematically a further alternative separation arrangement of the elements of a mask amplifier.

### DETAILED DESCRIPTION OF THE INVENTION

The invention is described with reference to the several embodiments shown in the attached drawings. These embodiments are only exemplary; the invention could take other forms.

FIG. 1 is a schematic representation of a mask amplifier 10 in accordance with a first embodiment of the invention. The mask amplifier 10 includes four elements: a microphone 12, a power supply 14, a circuit board or amplifier 16, and a speaker 18. (A mask amplifier could include more than four or fewer than four elements, and could include elements other than the particular four that are described herein.)

The mask amplifier 10 is shown mounted on a mask that is illustrated schematically at 20. The mask 20 has an outer skin 22, which is designed to seal against the face of the wearer. The mask 20 also has a nose cup 24 within the outer skin 22. (The invention is applicable also to masks that do not have nose cups.) The area inside the mask 20, that is, the mask volume within the seal provided by the outer skin 22, is indicated to the left of the skin in FIG. 1 with the reference numeral 26. The area not inside the mask volume, that is, outside of or forming part of the seal provided by the outer skin 22, is indicated to the right of the skin in FIG. 1 with the reference numeral 28.

One group 30 of elements of the mask amplifier 10 is located not inside the mask volume 26 of the mask 20. In the particular embodiment shown in FIG. 1, this group 30 includes only the speaker 18. The speaker 18 is shown as being attached to or mounted on the outer skin 22 at a location 32.

Another group 34 of elements of the mask amplifier 10 is separated from the first group 30 of elements and is located inside the mask volume 26 of the mask 20. In the embodiment illustrated in FIG. 1, this group 34 of elements includes the microphone 12, the circuit board 16, and the power supply 14. These elements 12-16 can be mounted at any suitable location inside the mask volume 26 of the mask 20. The microphone 12 is typically located close to the wearer's mouth. Preferably, but not necessarily, the power supply 14 is located adjacent the circuit board 16 to minimize the length of any wires needed between the power supply and the circuit board.

In the embodiment shown in FIG. 1, the group 30 of external elements of the mask amplifier 10 includes only the speaker 18. This group 30 of elements is electrically interconnected with the group 34 of internal elements by hard wiring or by a connector. Lead wires indicated schematically at 40 pass through the outer skin 22 between the speaker 18 and the inside 26 of the mask 20. In this case, the wires 40 electrically interconnect the external speaker 18 with the internal microphone 12 and the amplifier 16 and the power supply 14.

The speaker 18 if alone on the outside 28 of the mask 20 could be in a separate housing that clips on the mask, with two contacts that engage contacts on the mask. The contacts on the mask 20 could be a port that alternatively allows for attachment of a cable going to a speaker elsewhere on the user, such as the user's chest, or to a radio interface, or to a transmitter.

Alternative methods of establishing electrical interconnection between the external group 30 and the internal group 34 are possible. For example, wireless communication, such as radio frequency transmission, is possible between the external group 30 and the internal group 34. In that case, a separate power supply may be needed for each group 30 or 34 of elements. Other alternative methods of electrical interconnection of the external group 30 of elements and the internal group 34 of elements include infrared signaling, inductive coupling, and ultrasound.

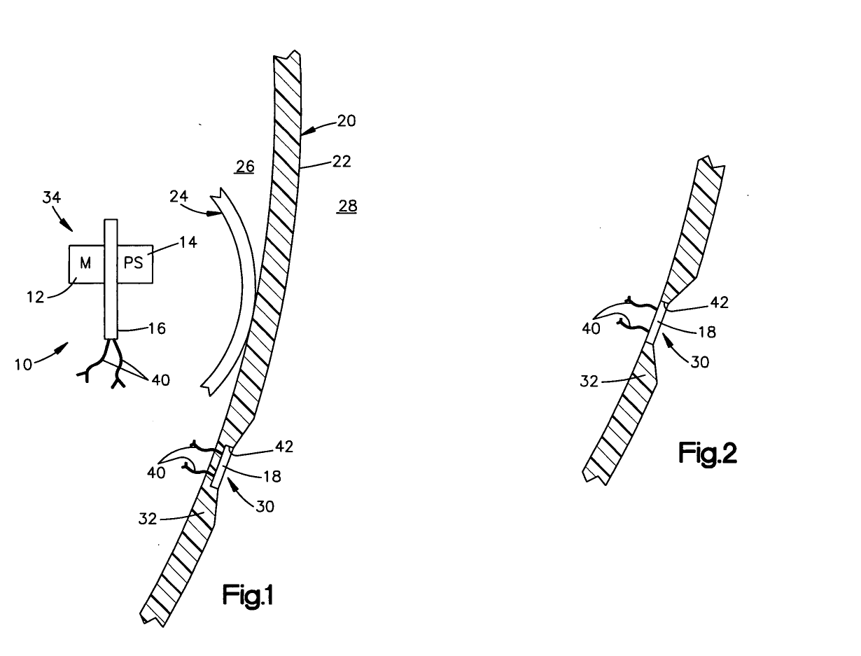

The speaker 18 may be mounted to the mask 20 adjacent or within an existing opening or docking port in the mask, as shown schematically at 42 in FIG. 2. Such an existing opening might be a voice emitter passage, or a filter port or dedicated accessory port, for example. There may be an existing seal member that would be replaced with the group of external elements of the mask amplifier that is configured to seal the opening in the mask.

Alternatively, the speaker 18 may be mounted to the mask 20 at a normally imperforate portion of the outer skin as shown in FIG. 1. In this case, the wires extend through an opening in the mask 20 that is formed for (dedicated to) these wires. Such an opening might be an opening in the rubber of the outer skin 22 or in the polycarbonate of the lens, for example. This opening could be filled and sealed with the external group 30 of elements, or with a member such as a grommet, for example, or with both, or in some other manner.

The speaker 18 may be attached to the mask 20 in any other one of various different ways. For example, the speaker 18 may be pushed in with a snap connect, utilizing a detent that moves sideways (for example, cammed out then biased back in). Alternatively, the speaker 18 may be screwed into the mask 20, supported with a friction fit, or with a secondary adapter such as a bracket that is specific to the mask, or with a clamp.

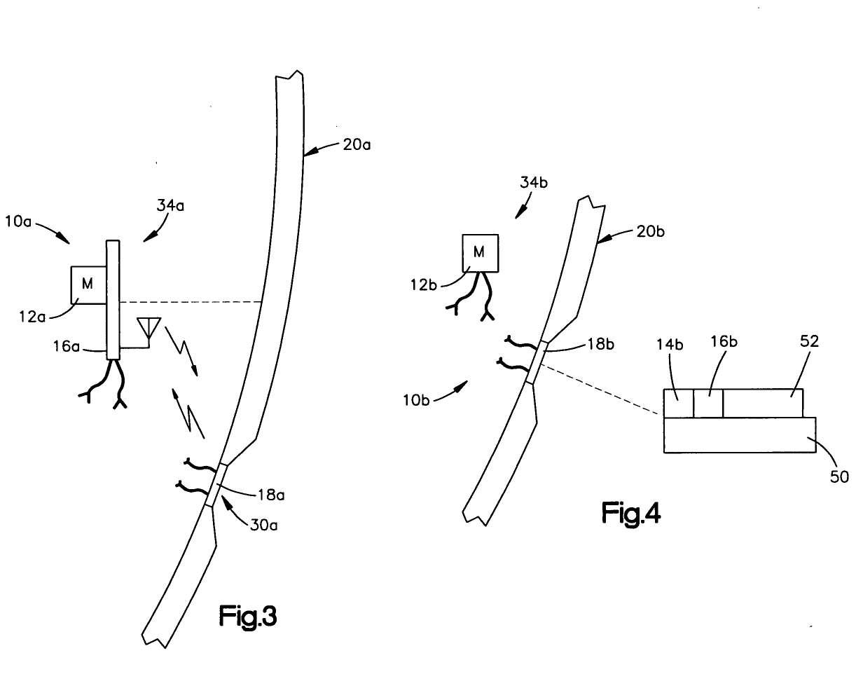

FIG. 3 illustrates schematically an alternative separation arrangement of the elements of a mask amplifier 10a. In the mask amplifier 10a shown in FIG. 2, the circuit board 16a and the microphone 12a are located inside the mask volume 26a of the mask 20a, while the other two elements (speaker 18a and power supply 14a) are located outside the mask volume 26a. The separation of elements shown in FIG. 2 is advantageous in that the power supply 14a and the speaker 18a are the size drivers (the largest units) of a mask amplifier 10a, so that separating the two small units (microphone 12a and circuit board 16a) would provide one small group 34a inside the mask 20a and only one large group 30a which can be located outside the mask. Also, because the mask amplifier 10a needs a power (on/off) switch, which is preferably located near the power supply 14a (to avoid extra wiring), the separation of elements that is illustrated in FIG. 2 keeps the power supply outside where the switch would be most easily accessible.

FIG. 3 illustrates schematically a further alternative separation arrangement of the elements of a mask amplifier 10b. In the mask amplifier 10b shown in FIG. 3, the speaker 18b and the microphone 12b are located on the mask 20b. The other two elements (amplifier 16b and power supply 14b) are located off the mask, on another user device, in this case, on the user's back plate 50, on which the user carries the air supply 52, etc.

From the above description of the invention, those skilled in the art will perceive improvements, changes, and modifications in the invention. Such improvements, changes, and modifications within the skill of the art are intended to be included within the scope of the appended claims.

Having described the invention, I claim:

1. Apparatus comprising:
a mask having a mask volume; and
a mask amplifier associated with the mask, the mask amplifier including a microphone, an amplifier, a power supply, and a speaker;
the speaker being mounted not inside the mask volume; and
the microphone and at least one other element of the mask amplifier being mounted inside the mask volume separate from the speaker.

2. Apparatus as set forth in claim 1 wherein the microphone and the amplifier and the power supply are mounted inside the mask volume.

3. Apparatus as set forth in claim 2 wherein the microphone and the amplifier and the power supply are mounted inside the mask volume as one unit.

4. Apparatus as set forth in claim 1 wherein the microphone and the amplifier are mounted inside the mask volume and the power supply is mounted separately from the microphone and the amplifier.

5. Apparatus as set forth in claim 4 wherein the power supply is mounted with the speaker.

6. Apparatus as set forth in claim 1 including hardwired electrical communication between the elements of the mask amplifier.

7. Apparatus as set forth in claim 1 wherein there is hardwired electrical communication between the mask amplifier elements that are mounted outside the mask volume and the mask amplifier elements that are mounted inside the mask volume.

8. Apparatus as set forth in claim 1 wherein there is wireless electrical communication between the mask amplifier elements that are mounted outside the mask volume and the mask amplifier elements that are mounted inside the mask volume.

9. Apparatus as set forth in claim 9 wherein the wireless electrical communication is radio frequency transmission.

10. Apparatus as set forth in claim 1 wherein there is infrared signaling communication between the mask amplifier elements that are mounted outside the mask volume and the mask amplifier elements that are mounted inside the mask volume.

11. Apparatus as set forth in claim 1 wherein there is inductive coupling communication between the mask amplifier elements that are mounted outside the mask volume and the mask amplifier elements that are mounted inside the mask volume.

12. Apparatus as set forth in claim 1 wherein there is ultrasound communication between the mask amplifier elements that are mounted outside the mask volume and the mask amplifier elements that are mounted inside the mask volume.

13. Apparatus as set forth in claim 1 wherein the speaker is mounted to the mask adjacent to or within an existing opening or docking port in the mask.

14. Apparatus as set forth in claim 13 wherein there is an existing seal member in the mask that is replaced with the group of external elements of the mask amplifier that includes the speaker.

15. Apparatus as set forth in claim 1 wherein the speaker is mounted to the mask at a normally imperforate portion of the outer skin of the mask.

16. Apparatus comprising:
a mask having a mask volume; and
a mask amplifier associated with the mask, the mask amplifier including a microphone, an amplifier, a power supply, and a speaker;
the speaker being mounted not inside the mask volume;
the microphone being mounted inside the mask volume separate from the speaker; and
at least one other element of the mask amplifier being mounted not inside the mask volume separate from the speaker.

17. Apparatus as set forth in claim 16 wherein the amplifier is mounted inside the mask volume together with the microphone.

18. Apparatus as set forth in claim 16 wherein the power supply and the amplifier are mounted inside the mask volume together with the microphone.

19. Apparatus as set forth in claim 16 wherein the power supply and the amplifier are mounted off the mask on another user device, such as a back plate.
